(19) United States
(12) Patent Application Publication
(10) Pub. No.: US 2009/0230266 A1
(43) Pub. Date: Sep. 17, 2009

(54) Universally Mountable Bollard Bracket

(75) Inventors: David U. Hillstrom, Calumet, MI (US); Thomas Pilarczyk, Brighton, MI (US)

Correspondence Address: HARNESS, DICKEY & PIERCE, P.L.C., P.O. BOX 828, BLOOMFIELD HILLS, MI, 48303, US

(73) Assignee: Marketing Displays, Inc., Farmington Hills, MI (US)

(21) Appl. No.: 12/046,674

(22) Filed: Mar. 12, 2008

(51) Int. Cl. F16M 13/00

(52) U.S. Cl. 248/230.9; 248/219.4; 29/525.01

(57) ABSTRACT

A bracket for attaching an advertising unit to a support structure includes a metal plate having multiple cavities. A first bite member extends into a first cavity and is oriented to engage the support structure in a first bracket orientation when the support structure is received in the first cavity. A second bite member extends into a second cavity and is oriented parallel to the first bite member. The second bite member engages the support structure in the first bracket orientation when the support structure is also received in the second cavity. A third bite member extends into a third cavity and is oriented to engage the support structure in a second bracket orientation. A fourth bite member extends into the third cavity and is oriented parallel to and oppositely facing the third bite member. The third and fourth bite members engage the support structure in the second bracket orientation.

### FIELD

The present disclosure relates to brackets used to mount advertisement signs to support members such as posts or bollards.

### BACKGROUND

The statements in this section merely provide background information related to the present disclosure and may not constitute prior art.

Advertising is an important component at many point-of-purchase locations such as gasoline filling stations. These locations utilize a variety of devices to mount and display advertising on various structures on the property. Some of these advertising assemblies may be permanently fixed displays secured to the building structure at the point of purchase location. Other advertising assemblies may be temporary displays releasably secured to fixtures at the point of purchase location.

One opportunity for display of temporary advertising is the bollards or posts which extend upwardly from the ground to protect various building structures or fixtures at the point of purchase location. For example, bollards are utilized around filling station islands to protect the filling station gas pumps against impact by the vehicles driving by and utilizing the gas pumps.

Presently, advertising displays that are rigidly secured to the bollards do not allow for adjustment when the orientation of the advertising media change or if a desired orientation of the bollard is not available. This lack of adjustment can result in the new advertising media being extended into the path of travel of entering or exiting vehicles or can limit the advertising media sizes or geometries that can be displayed. In addition, spacing and orientation between bollards commonly varies both between bollard designs at a given station, and between bollard designs used at different stations. The inconsistent bollard spacing and orientation can prevent installation of advertising at some locations.

### SUMMARY

According to an embodiment of the present disclosure, a universally mountable bollard bracket for attaching an advertising unit to a support structure includes a first set of bite members oriented to engage the support structure in a first bracket orientation. A second set of bite members is oriented to engage the support structure in a second bracket orientation.

According to additional embodiments, a bracket for attaching an advertising unit to a support structure includes a metal plate having multiple cavities. A first bite member extends into a first cavity and is oriented to engage the support structure in a first bracket orientation when the support structure is received in the first cavity. A second bite member extends into a second cavity and is oriented parallel to the first bite member. The second bite member engages the support structure in the first bracket orientation when the support structure is also received in the second cavity. A third bite member extends into a third cavity and is oriented to engage the support structure in a second bracket orientation. A fourth bite member extends into the third cavity and is oriented parallel to and oppositely facing the third bite member. The third and fourth bite members engage the support structure in the second bracket orientation.

According to other embodiments, a bracket for attaching an advertising unit to a support structure includes first and second channels created in the bracket having a first bite member of a first set of bite members positioned in the first channel and a second bite member of the first set of bite members positioned in the second channel. The first and second channels operate to receive the support structure in a first bracket orientation and permit the first and second bite members to be oriented for engagement with the support structure. A third channel created in the bracket has a second set of bite members positioned in the third channel. The third channel receives the support structure in a second bracket orientation and permits the second set of bite members to be oriented for engagement with the support structure. Parallel first and second plate sections connect the bracket to the advertising unit.

According to still other embodiments, an assembly for attaching a sign to a support structure includes a bracket having first and second flanges oriented parallel to each other and first and second plate sections defining a V-shape; first and second channels created in the bracket both receiving at least a portion of the support structure when the bracket is oriented in a first bracket orientation; and a third V-shaped channel created in the bracket operable to receive the support structure when the bracket is oriented in a second bracket orientation. A support structure has a member at least partially received in the first and second cavities in a first orientation of the bracket and at least partially received in a space created by the V-shape defined between the first and second plate sections in a second orientation of the bracket. At least one flexible strap is received in a pair of apertures positioned on opposite sides of each of the cavities of the bracket. The strap is looped about the support structure and is adapted to be tightened to engage the bracket to the support structure in either the first or second bracket orientation.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a rear perspective view of a sign assembly supported to a bollard assembly using a universal bracket of the present disclosure;

FIG. 2 is a rear perspective view of the universal bracket of FIG. 1 shown transversely oriented from the orientation of FIG. 1;

FIG. 3 is a top plan view of the sign assembly of FIG. 1;

FIG. 4 is a top plan view of the sign assembly of FIG. 2;

FIG. 5 is a top plan view of a pre-formed plate used to create a universal bracket of the present disclosure;

FIG. 6 is a top plan view of an after-formed universal bracket;

FIG. 7 is a side elevational view of the bracket of FIG. 6;

FIG. 8 is a top plan view of the bracket of FIG. 6;

FIG. 9 is a rear perspective view of an angle member used to support the bracket of FIG. 1;

FIG. 10 is an end elevational view of the angle member of FIG. 9;

FIG. 11 is a rear perspective view showing an advertisement unit having a bracket of the present disclosure adapted for support to a horizontal member of a bollard assembly; and

FIG. 12 is a rear perspective view of the bracket of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

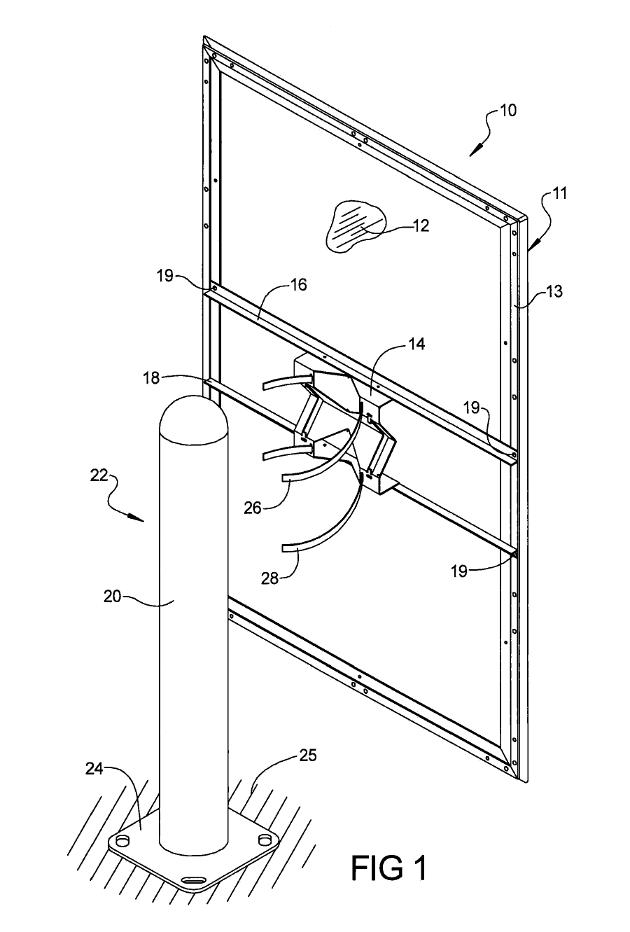

Referring to FIG. 1, a sign assembly 10 includes an advertisement unit 11 such as a sign 12 connected to a support frame 13. Sign 12 can include multiple types of advertisements, including but not limited to backlit signs, paper advertisements, posters, and the like. A bracket assembly 14 of the present disclosure can be fastenably connected to advertisement unit 11 using a first and a second angle member 16, 18 which can be releasably fastened to support frame 13 using a plurality of fasteners 19. Advertisement unit 11 is adapted to advertise items for sale at a business location for example. In the embodiment shown a post member 20 of a support structure 22 such as a bollard assembly can be a vertically oriented member which can be fixed to a support flange 24 or embedded directly in the ground or in a concrete/cement base. Support structure 22 can also be modified to provide additional post members and/or to orient the post member(s) in non-vertical orientations. Support flange 24 is connected by fasteners (not shown) to a support surface 25 such as a concrete or wood pad, a driving surface, a ground surface, and the like. Sign assembly 10 can be connected to post member 20 using first and second strap members 26, 28 engaged to bracket assembly 14. It should also be evident that the flexibility of first and second strap members 26, 28 allow sign assembly 10 to be attached to objects other than bollard posts, including but not limited to sign or fence posts, trees, building structure, and the like which can have circular, rectangular, or other geometric shapes.

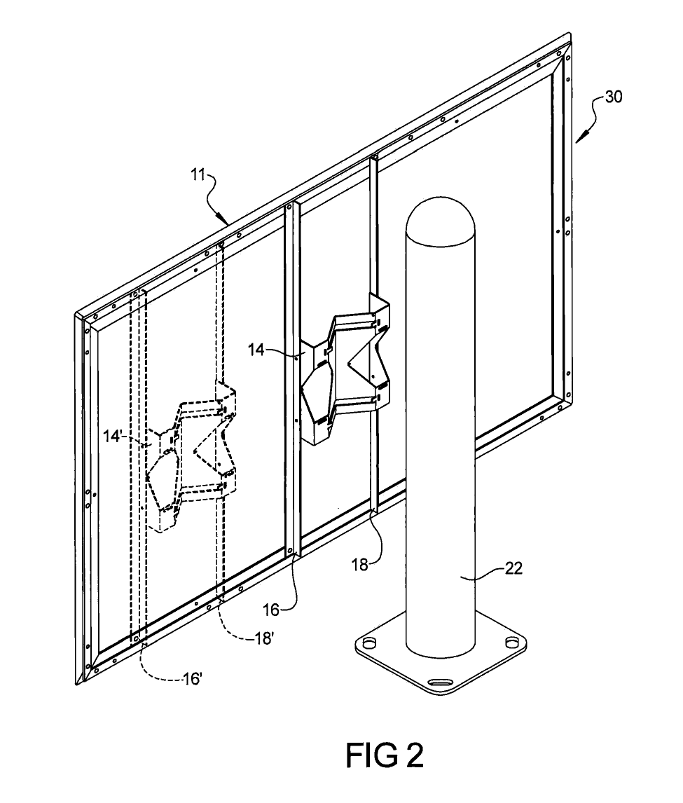

Referring to FIG. 2 and again to FIG. 1, bracket 14 can be oriented in any angular increment and in several embodiments can be oriented in 90 degree increments. As shown in FIG. 2 bracket 14 can therefore be transversely oriented with respect to the orientation shown in FIG. 1. This permits bracket 14 to be mounted to advertisement unit 11, or oriented together with advertisement unit 11 in either a first or a transversely configured second (e.g.: horizontal or vertical) orientation to attach advertisement unit 11 in multiple orientations to suit the size and geometry of advertisement unit 11 and support structure 22. The location of first and second angle members 16, 18 and therefore the location of bracket 14 can be varied as shown in phantom in FIG. 2 as first and second angle members 16′, 18′ and bracket 14′, to also provide flexibility in supporting multiple embodiments and geometries of advertisement unit 11. Two or more “bracket groups” including two or more sets of both first and second angle members 16, 18 and brackets 14 can be used to support a single advertisement unit 11.

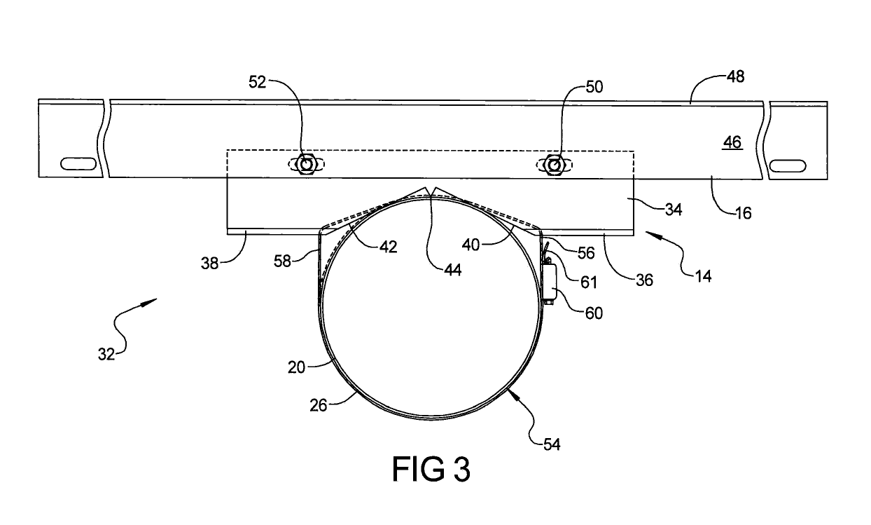

Referring to FIG. 3, a first orientation of a first mount assembly 32 includes a flange 34 of bracket 14 fastenably connected to first angle member 16. Oriented transversely to flange 34 (away from the viewer as shown in FIG. 3) are a first face 36 and a second face 38. A V-shaped aperture is created in flange 34 having a first contact edge 40 and a second contact edge 42 oriented at an oblique angle with respect to each other. At a juncture of first and second contact edges 40, 42 a first bite member 44 is provided having a triangular-shaped body 45. Bracket 14 is connected to first angle member 16 by fastenably connecting flange 34 to a first leg 46 of first angle member 16. A second leg 48 is oriented transverse to first leg 46. A plurality of fasteners including a first and a second fastener assembly 50, 52 are inserted through each of first leg 46 and flange 34 and torqued or set to connect flange 34 to first leg 46.

First mount assembly 32 is connected to post member 20 using first and second strap members 26, 28 (only first strap member 26 is visible in this view). Post member 20 is positioned within the V-shaped aperture defined by first and second contact edges 40, 42 until an outer surface 54 of post member 20 contacts each of first and second contact edges 40, 42. It is also desirable when the first and second strap members 26, 28 are tightened that first bite member 44 also contacts outer surface 54 to help prevent rotation of first mount assembly 32 with respect to post member 20.

Installation of second strap member 28 is similar to first strap member 26 therefore the discussion that follows with respect to first strap member 26 is equally applicable to second strap member 28. A first strap portion 56 of first strap member 26 is inserted through first face 36 and is looped to second face 38 from which a second strap portion 58 extends and completes the circumference of first strap member 26 about post member 20. A strap joining fastener 60 is provided to frictionally engage first strap member 26 such that a free end 61 extends beyond strap joining fastener 60 as strap joining fastener 60 is operated. Strap joining fastener 60 is torqued until outer surface 54 of post member 20 contacts at least first bite member 44 and at least one of first and second contact edges 40, 42. The amount of contact between first mount assembly 32 and post member 20 depends in part on a diameter of post member 20. It is also noted that the diameter of post member 20 can be large enough that contact between outer surface 54 and each of first and second contact faces 40, 42 can occur without contact between outer surface 54 and first bite member 44.

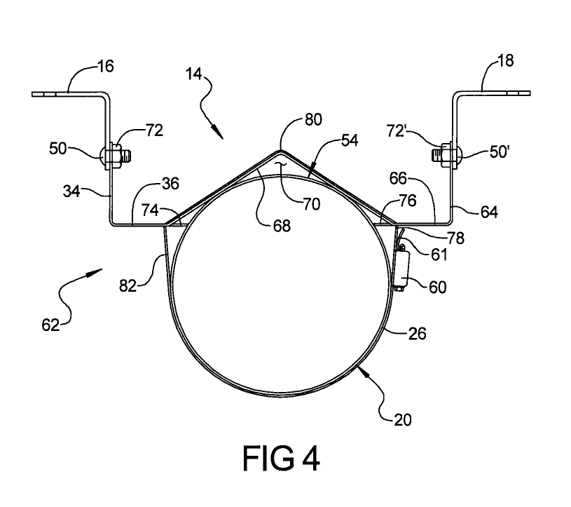

Referring to FIG. 4, a second mount assembly 62 is created by rotating bracket 14 approximately 90 degrees with respect to the configuration of first mount assembly 32 shown in reference to FIG. 3. Different portions of bracket 14 are used to engage post member 20 with second mount assembly 62. These include a second flange 64 which is substantially parallel to flange 34, and an opposing face 66 which is substantially co-axially aligned with first face 36. A V-shaped segment 68 created between first face 36 and opposing face 66 defines a V-shaped cavity 70.

The orientation of second mount assembly 62 with respect to post member 20 more clearly shows the installation of bracket 14 with respect to each of first and second angle members 16, 18. Flange 34 is connected to first angle member 16 using first fastener assembly 50 which can include a nut 72. Similarly, second flange 64 is connected to second angle member 18 using first fastener assembly 50′ which can include a nut 72′. Other fastener designs can also be used for first fastener assembly 50 such as but not limited to bolt and nut combinations and rivets for which nuts 72, 72′ are not required.

A first bite or contact element 74 having a rectangular-shaped body 75 extends laterally away from first face 36 and a second bite or contact element 76 having a rectangular-shaped body 77 extends laterally away from opposing face 66. First and second contact elements 74, 76 define a first pair of contact elements. Each of first and second contact elements 74, 76 are directed toward each other and extend partially into V-shaped cavity 70. Second mount assembly 62 is oriented as shown having outer surface 54 of post member 20 in contact with each of first and second contact elements 74, 76 and a portion of post member 20 received within V-shaped cavity 70 as shown. Contact between outer surface 54 and each of first and second contact elements 74, 76 acts to prevent rotation of second mount assembly 62 with respect to post member 20. First strap member 26 is then engaged as follows. A first strap portion 78 is passed through opposing face 66 and behind V-shaped segment 68 such that a second strap portion 80 contacts V-shaped segment 68. A third strap portion 82 extends through first face 36 and loops about the remainder of post member 20 to be engaged by strap joining fastener 60 as previously described.

Referring to FIG. 5, a flat metal plate 84 has a plurality of operations performed on it as a sub-assembly prior to creation of bracket 14. Metal plate 84 includes each of a first and second fastener through aperture 86, 88 having an aperture space dimension “A”. A first bollard receiving aperture or cavity 89 is created having each of a first aperture wall 90 and a second aperture wall 91 and opposed mirror image first and second aperture walls 90′, 91′. A second bite member 92 is positioned opposite to first bite member 44. A first and second strap receiving elongated aperture 94, 96 are positioned on opposite sides of first bollard receiving aperture 89 and are oriented parallel to each other. A third and a fourth strap receiving elongated aperture 98, 100 are also positioned on opposite sides of first bollard receiving aperture 89 and are oriented transversely with respect to both first and second strap receiving elongated apertures 94, 96.

A third bite or contact element 102 having a rectangular-shaped body 103 and a fourth bite or contact element 104 having a rectangular-shaped body 105 are oppositely positioned to face each other across a first longitudinal slot or cavity 106. Similarly, first and second contact elements 74, 76 are oppositely positioned from each other across a second longitudinal slot or cavity 108. First and second longitudinal slots 106, 108 are positioned on opposite sides of first bollard receiving aperture 89. Third and fourth contact elements 102, 104 define a second pair of contact elements. A third bite member 110 oriented similar to first bite member 44 is created in a second bollard receiving aperture or cavity 112. A fourth bite member 114 similarly oriented with respect to second bite member 92 is also created in second bollard receiving aperture 112. First and fourth bite members together define a first set of bite members. First and second contact elements 74, 76 and third and fourth contact elements 102, 104 together define a second set of bite members.

Second bollard receiving aperture 112 is geometrically similar in shape to first bollard receiving aperture 89, however, second bollard receiving aperture 112 is oriented in a mirror image arrangement compared to first bollard receiving aperture 89. Fifth and sixth strap receiving elongated apertures 116, 118 are created on opposite sides of second bollard receiving aperture 112 similar to first and second strap receiving elongated apertures 94, 96 in their spatial relationship to first bollard receiving aperture 89. A seventh and an eighth strap receiving elongated aperture 120, 122 similar to third and fourth strap receiving elongated apertures 98, 100 are transversely oriented with respect to fifth and sixth strap receiving elongated apertures 116, 118. A third and fourth fastener through aperture 124, 126 are positioned at an opposite end of metal plate 84 with respect to first and second fastener through apertures 86, 88 and have a similar aperture spacing “A” as first and second fastener through apertures 86, 88.

A plurality of bend axis lines are denoted in FIG. 5 representing bend axes to re-configure metal plate 84 from the substantially flat shape shown in FIG. 5 to the finished geometry of bracket 14. These bend axes include each of a first bend axis 128, a second bend axis 139, a third bend axis 132, a fourth bend axis 134, and a fifth bend axis 136. First bend axis 128 separates a first plate section 138 from a second plate section 140. Each of first and second faces 36, 38 are defined by second plate section 140. Second bend axis 130 separates second plate section 140 from a third plate section 142. Third bend axis 132 divides metal plate 84 substantially in half and also separates third plate section 142 from a fourth plate section 142. Items such as the bollard receiving apertures, the contact elements, and the elongated apertures of metal plate 84 are substantially mirror image configurations of each other divided by third bend axis 132. Fourth bend axis 134 separates fourth plate section 144 from a fifth plate section 146, and fifth bend axis 136 separates fifth plate section 146 from a sixth plate section 148 which includes each of third and fourth fastener through apertures 124, 126.

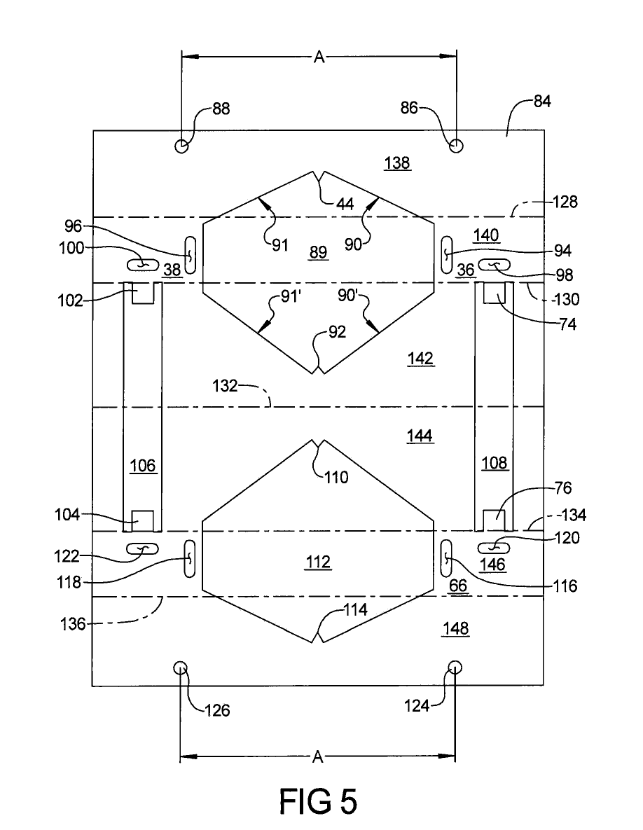

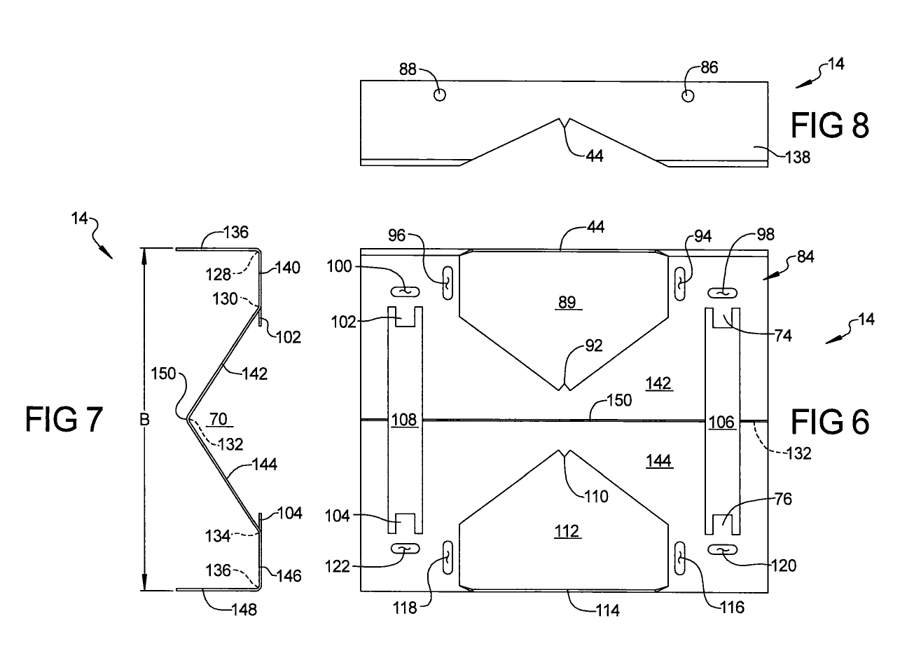

Referring now to FIG. 6, the configuration of bracket 14 is shown in its finished condition after making the plurality of bends about the first, second, third, fourth, and fifth bend axes 128, 130, 132, 134, and 136 described in reference to FIG. 5. As previously noted, third bend axis 132 creates a substantially mirror image configuration about a strap engagement center bracket bend 150. Each of the first through fourth bite members 44, 92, 110, and 114 are axially aligned when bracket 14 is in its finished shape. This allows any or all of the bite members to subsequently contact the post member (not shown in this view) when the post member is subsequently received in both first bollard receiving aperture 89 and second receiving aperture 112.

Referring to FIG. 7, bracket 14 has a flange-to-flange spacing dimension “B” between first plate section 138 and sixth plate section 148 which are configured substantially parallel to each other. By bending metal plate 84 at third bend axis 132 to create strap engagement center bracket bend 150, and V-shaped cavity 70, third and fourth contact elements 102, 104 are configured directly facing each other. First and second contact elements 74, 76 are not shown in this view, however, they also directly face each other similar to third and fourth contact elements 102, 104. The overall configuration of bracket 14 as viewed in FIG. 7 creates a substantially M-shaped configuration.

Referring to FIG. 8 and again to FIG. 7, because first plate section 138 is oriented substantially parallel to sixth plate section 148, first fastener through aperture 88 is aligned substantially co-axially with third fastener through aperture 124 (not clearly visible in this view), and second fastener through aperture 88 is aligned substantially co-axial with fourth fastener through aperture 124 (not clearly visible in this view).

Referring again to FIGS. 1, 2, and 6, bracket 14 oriented in the first orientation has first strap member 26 inserted through first and second strap receiving elongated apertures 94, 96 and second strap member 28 inserted through fifth and sixth strap receiving elongated apertures 116, 118. In the second orientation of bracket 14 shown in FIG. 2, first strap member 26 will be inserted through third and seventh strap receiving elongated apertures 98, 120 and second strap member 28 will be inserted through fourth and eighth strap receiving elongated apertures 100, 122.

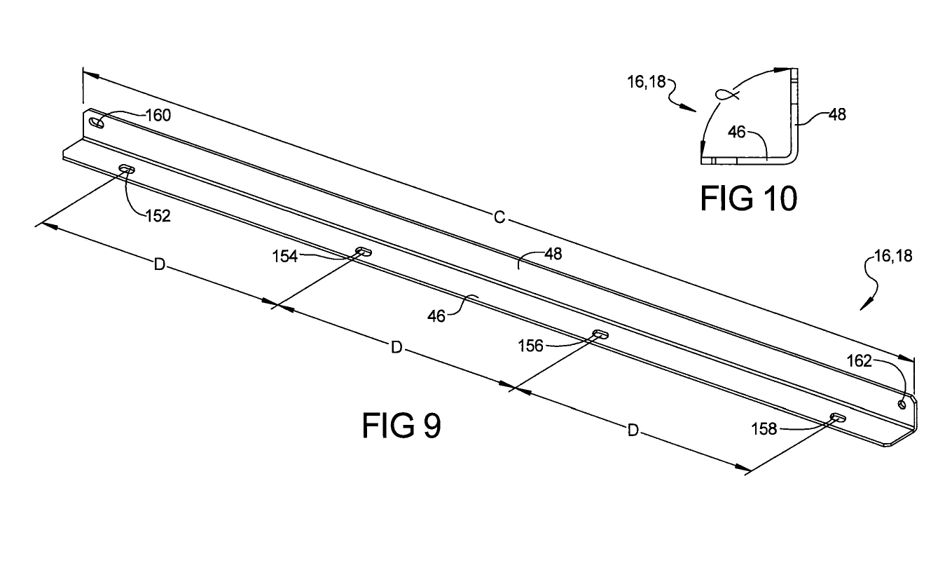

Referring to FIGS. 9 and 10, the geometry of both first and second angle members 16, 18 are identical with each other and the following discussion of features therefore applies equally to both the first and second angle members 16, 18. First, second, third, and fourth elongated apertures 152, 154, 156, 158 which are co-axially aligned with each other are created in first leg 46. An alignment elongated aperture 160 and a substantially circular aperture 162 are created in second leg 48, with elongated aperture 160 used to provide tolerance in aligning apertures 160, 162 with fastener receiving apertures (not visible in this view) on support frame 13. First and second angle members 16, 18 each have a total length “C”. A common spacing is used between proximate ones of the first, second, third, and fourth elongated apertures 152, 154, 156, 158. This common spacing is an aperture-to-aperture spacing “D”. Aperture-to-aperture spacing “D” is substantially equal to aperture spacing dimension “A” shown in reference to FIG. 5 between first and second fastener through apertures 86, 88 and between third and fourth fastener through apertures 124, 126.

First and second angle members 16, 18 can therefore be mounted on bracket 14 in three different positions each represented by aperture-to-aperture spacing “D”. Alignment elongated aperture 160 is provided as an elongated aperture to allow for fit up tolerance when each of the first and second angle members 16, 18 are connected to frame 13 shown in reference to FIG. 1. A leg included angle alpha which according to several embodiments is substantially 90 degrees is created between first and second legs 46, 48 to provide for consistent alignment of bracket 14 when bracket 14 is connected to first and second angle members 16, 18.

Referring again to FIG. 1, it is noted that bracket 14 can be directly connected to support frame 13 if structure is available on support frame 13 similar to the connecting features of first and second angle members 16, 18. First and second angle members 16, 18 are therefore not required for every installation of bracket 14 and can therefore be eliminated in some embodiments of the present disclosure.

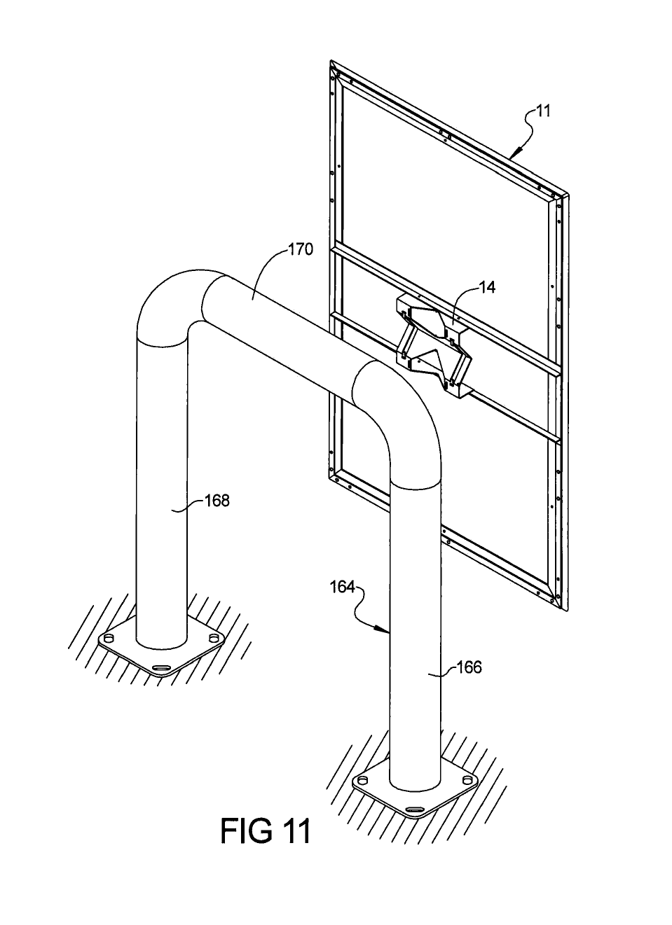

Referring to FIG. 11, advertisement unit 11 having bracket 14 installed as shown can be also installed on a multiple post bollard assembly 164 by connecting bracket 14 to any of a first vertical post 166, a second vertical post 168, or a connecting post 170. Advertisement unit 11 can also be reoriented from the configuration shown in FIG. 11 by rotating advertisement unit 11 approximately 90 degrees. This allows advertisement unit 11 to be installed in 90 degree rotated increments on any of the first, second vertical posts 166, 168 or horizontal connecting post 170. Also, by further providing or modifying structure of support frame 13 to receive first and second angle members 16, 18 in alternate orientations, advertisement unit 11 can be oriented in substantially any rotational position with bracket 14 mounted to first vertical post 166, second vertical post 168, or connecting post 170.

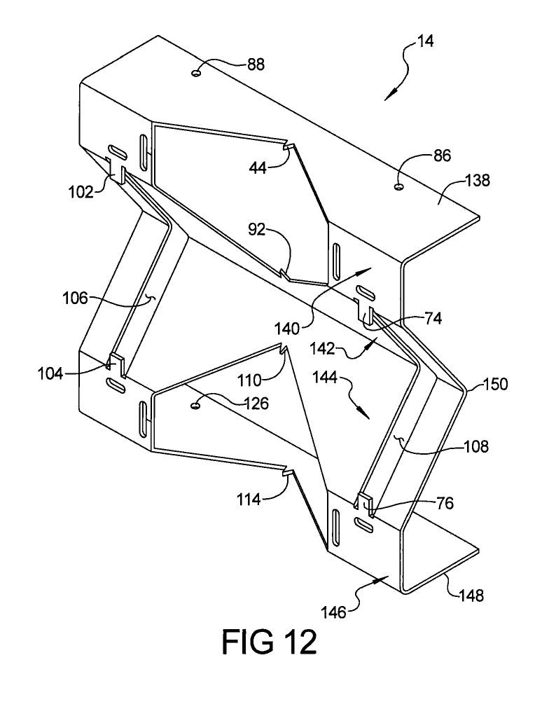

Referring to FIG. 12 and again to FIGS. 1 and 2, first and fourth bite members 44, 114 extend most directly toward a surface of the bollard post (not shown in this view) due to the parallel configuration of first and sixth plate sections 138, 148 which first and fourth bite members 44, 114 extend co-planar with. Second and third bite members 92, 110 are co-planar with third and fourth plate sections 142, 144 respectively, and will therefore contact the bollard post after first and fourth bite members 44, 114. When bracket 14 is rotated 90 degrees from the position shown, or otherwise oriented to engage the bollard post with first, second, third, and fourth contact elements 74, 76, 102, 104, each of the contact elements 74, 76, 102, 104 are similarly oriented, and therefore can simultaneously contact the bollard post. The plate sections 138, 148 define an outside limit of bracket 14. Second and third bite members 92, 110 are provided in the event the support structure 22 cannot be engaged by both first and fourth bite members 44, 114. For example, engagement can be obtained at both first and second bite members 44, 92 if the support structure cannot contact third or fourth bite members 110, 114.

Referring again to FIGS. 1 through 5, operationally, bracket 14 can be used for attaching advertising unit 11 to support structure 22. The bracket 14 is initially formed from metal plate 84 having a plurality of cavities 89, 106, 108, and 112 created in the metal plate 84 by for example a punching or a die cut operation. The metal plate is then bent at a plurality of bend axes to create the bracket shape of FIG. 1. A first one of the bite members 44 extends into a first one of the cavities (cavity 89) and is oriented as shown in FIG. 3 to engage the post 20 of support structure 22 in a first bracket orientation when the support structure 22 is received in the first one of the cavities (cavity 89). Second bite member 114 extends into a second one of the cavities (cavity 112) and is oriented parallel to the first bite member 44 when bracket 14 is in its final bent or formed condition. The second bite member 114 operates to engage the support structure 22 in the first bracket orientation when the support structure 22 is also received in the second one of the cavities (cavity 112).

A third bite member (bite member 74) extends into a third one of the cavities (cavity 108) and is oriented to engage the support structure 22 in the second bracket orientation as shown in FIG. 4. A fourth bite member 76 also extends into the third one of the cavities (cavity 108) and is oriented parallel to and oppositely facing with respect to the third bite member 74, the fourth bite member 76 is operable with the third bite member 74 to engage the support structure 22 in the second bracket orientation. A fifth bite member 102 extends into a fourth one of the cavities (cavity 106) and is oriented to engage the support structure 22 in the second bracket orientation. A sixth bite member 104 also extends into the fourth one of the cavities (cavity 106) and is oriented parallel to and oppositely facing with respect to the fifth bite member 103 when bracket 14 is in its final bent or formed condition. The sixth bite member 104 is operable with the fifth bite member 102 to engage the support structure 22 in the second bracket orientation.

Brackets 14 of the present disclosure provide several advantages. By providing multiple cavities some of which are oriented transverse to other ones of the cavities, bracket 14 can be oriented in either a first or second bracket orientation with respect to a support member such as a bollard post. By creating bite members extending partially into each of the cavities, the bite members can engage the support member to prevent rotation of the bracket 14 to accommodate wind or rotational loads applied to the attached sign or advertisement unit. Elongated apertures provided at opposites sides or walls of the bracket about each of the cavities provide for a flexible strap to be received in the apertures and looped about the support structure proximate to the location of the bite members to maximize engagement by the bite members. Braces 16, 18 having apertures aligned with apertures of the bracket 14 provide for multiple connection locations of the bracket to the advertisement unit. By forming the bracket from a single plate of metal, the bracket is homogenous and requires no welding or further pieces.

What is claimed is:

1. A bracket for attaching an advertising unit to a support structure, the bracket comprising:
a first set of bite members oriented to engage the support structure in a first bracket orientation; and
a second set of bite members oriented to engage the support structure in a second bracket orientation.

2. The bracket of claim 1, further comprising:
first and second channels created in the bracket having a first bite member of the first set of bite members positioned in the first channel and a second bite member of the first set of bite members positioned in the second channel, the first and second channels operating to receive the support structure in the first bracket orientation; and
a third channel created in the bracket having the second set of bite members positioned in the third channel, the third channel operating to receive the support structure in the second bracket orientation.

3. The bracket of claim 2, wherein the first and second bite members each have a triangular-shaped body.

4. The bracket of claim 2, wherein the second set of bite members includes two pairs of bite members, a first pair having opposed third and fourth bite members, and a second pair having opposed fifth and sixth bite members, the third, fourth, fifth, and sixth bite members each having a rectangular-shaped body.

5. The bracket of claim 2, further comprising elongated apertures positioned in plate sections of the bracket oppositely about each of the first, second, and third cavities.

6. The bracket of claim 1, further comprising parallel first and second plate sections operating to connect the bracket to the advertising unit.

7. The bracket of claim 6, wherein the bracket defines an “M” shape including:
co-planar third and fourth plate sections, the third plate section extending directly from and oriented transverse to the first plate section, and the fourth plate section extending directly from and oriented transverse to the second plate section; and
fifth and sixth plate sections defining a V-shape homogenously connected to each other, the fifth plate section extending directly from the third plate section and the sixth plate section extending directly from the fourth plate section.

8. The bracket of claim 6, wherein the second set of bite members extend directly from and co-planar to the third and fourth plate sections.

9. The bracket of claim 1, wherein the second bracket orientation is transverse to the first bracket orientation.

10. A bracket for attaching an advertising unit to a support structure, the bracket comprising:
a metal plate having a plurality of cavities created in the metal plate;
a first bite member extending into a first one of the cavities and oriented to engage the support structure in a first bracket orientation when the support structure is received in the first one of the cavities;
a second bite member extending into a second one of the cavities and oriented parallel to the first bite member, the second bite member operating to engage the support structure in the first bracket orientation when the support structure is also received in the second one of the cavities;
a third bite member extending into a third one of the cavities and oriented to engage the support structure in a second bracket orientation; and
a fourth bite member extending into the third one of the cavities and oriented parallel to and oppositely facing with respect to the third bite member, the fourth bite member operable with the third bite member to engage the support structure in the second bracket orientation.

11. The bracket of claim 10, further comprising:
parallel first and second plate sections; and
a V-shaped aperture created in a flange defined by each of the first and second plate sections.

12. The bracket of claim 11, wherein the V-shaped aperture of each of the first and second plate sections each include a first contact edge and a second contact edge oriented at an oblique angle with respect to the first contact edge.

13. The bracket of claim 12, wherein the first and second bite members are individually provided at a juncture of the first and second contact edges and each of the first and second bite members include a triangular-shaped body.

14. The bracket of claim 10, further comprising:
a fifth bite member extending into a fourth one of the cavities and oriented to engage the support structure in the second bracket orientation; and
a sixth bite member extending into the fourth one of the cavities and oriented parallel to and oppositely facing with respect to the fifth bite member, the sixth bite member operable with the fifth bite member to engage the support structure in the second bracket orientation.

15. The bracket of claim 14, wherein each of the third, fourth, fifth, and sixth bite members have a rectangular-shaped body.

16. A bracket for attaching an advertising unit to a support structure, the bracket comprising:
first and second channels created in the bracket having a first bite member of a first set of bite members positioned in the first channel and a second bite member of the first set of bite members positioned in the second channel, the first and second channels operating to receive the support structure in a first bracket orientation and permit the first and second bite members to be oriented for engagement with the support structure;
a third channel created in the bracket having a second set of bite members positioned in the third channel, the third channel operating to receive the support structure in a second bracket orientation and permit the second set of bite members to be oriented for engagement with the support structure; and
parallel first and second plate sections operating to connect the bracket to the advertising unit.

17. The bracket of claim 16, further including co-planar third and fourth plate sections, the third plate section extending directly from and oriented transverse to the first plate section, and the fourth plate section extending directly from and oriented transverse to the second plate section.

18. The bracket of claim 17, further including fifth and sixth plate sections defining a V-shape homogenously connected to each other, the fifth plate section extending directly from the third plate section and the sixth plate section extending directly from the fourth plate section.

19. The bracket of claim 16, further including a pair of elongated strap receiving apertures oppositely positioned about each of the cavities of the bracket, adapted to slidably receive a flexible strap.

20. The bracket of claim 16, wherein the bracket defines an M-shape with the first and second plate sections defining an outside limit of the bracket.

21. An assembly for attaching a sign to a support structure, the assembly comprising:
a bracket having:
first and second flanges oriented parallel to each other and first and second plate sections defining a V-shape;
first and second channels created in the bracket both receiving at least a portion of the support structure when the bracket is oriented in a first bracket orientation; and
a third V-shaped channel created in the bracket operable to receive the support structure when the bracket is oriented in a second bracket orientation;
a support structure having a member at least partially received in the first and second cavities in a first orientation of the bracket, and at least partially received in a space created by the V-shape defined between the first and second plate sections in a second orientation of the bracket; and
at least one flexible strap received in a pair of apertures positioned on opposite sides of each of the cavities of the bracket, the strap looped about the support structure and adapted to be tightened to engage the bracket to the support structure in either the first or second bracket orientation.

22. The assembly of claim 21, wherein the bracket further includes:
a first set of bite members including an individual bite member extending into each of the first and second cavities and oriented to engage the support structure in the first bracket orientation; and
a second set of bite members having individual second bite members extending into the V-shaped channel and directed opposite to each other to engage the support structure in the second bracket orientation.

23. The assembly of claim 22, wherein the individual bite members of the first set of bite members includes a triangular-shaped body.

24. The assembly of claim 23, wherein a first bite member of the first set of bite members is oriented parallel to a second bite member of the first set of bite members.

25. The assembly of claim 22, wherein the individual second bite members of the second set of bite members each includes a rectangular-shaped body.

26. The assembly of claim 21, further comprising first and second L-shaped braces each fastenably connected to one of the first and second flanges of the bracket and fastenably connected to the sign.

27. A method for connecting a sign to a support structure using a bracket, the bracket including first and second flanges oriented parallel to each other and first and second plate sections defining a V-shape, the method comprising:
creating first and second channels in the bracket both receiving at least a portion of the support structure when the bracket is oriented in a first bracket orientation;
forming a third V-shaped channel in the bracket operable to receive the support structure when the bracket is oriented in a second bracket orientation;
aligning the bracket with respect to a member of the support structure so the member is at least partially received in either the first and second cavities in the first bracket orientation, or in a space created by the V-shape defined between the first and second plate sections in the second bracket orientation;
looping at least one flexible strap through a pair of apertures positioned on opposite sides of each of the cavities of the bracket and about the support structure; and
tightening the strap to engage the bracket to the support structure in either the bracket first or second orientation.

28. The method of claim 27, further comprising fastening the bracket to at least one L-shaped brace member.

29. The method of claim 28, further comprising fastening the at least one L-shaped brace member to a frame supporting the sign.

30. The method of claim 27, further comprising looping a second one of the at least one flexible strap through a second pair of the apertures of the bracket and about the support structure.

31. The method of claim 30, further comprising:
extending opposed bite members partially into the space created by the V-shape defined between the first and second plate sections; and
continuing the tightening operation until the opposed bite members engage the support structure.

32. The method of claim 27, further comprising creating a V-shaped bite member extending into each of the first and second channels.

33. The method of claim 31, further comprising continuing the tightening operation until the V-shaped bite member in each of the first and second channels engages the support structure.
